(19) United States
(12) Patent Application Publication
(10) Pub. No.: US 2022/0043634 A1
(43) Pub. Date: Feb. 10, 2022

(54) Compact Digitization System for Generating Random Numbers

(71) Applicant: Quside Technologies S.L., Barcelona (ES)

(72) Inventors: Carlos ABELLAN, Barcelona (ES); Domenico TULLI, Barcelona (ES); Waldimar AMAYA, Barcelona (ES); José MARTINEZ, Barcelona (ES)

(21) Appl. No.: 17/509,993

(22) Filed: Oct. 25, 2021

Related U.S. Application Data
(63) Continuation of application No. PCT/EP2020/061594, filed on Apr. 27, 2020.

(30) Foreign Application Priority Data
Apr. 26, 2019 (EP) 19382318.4

(51) Int. Cl. G06F 7/58; G06F 7/02

(52) U.S. Cl. CPC G06F 7/588; G06F 7/02

(57) ABSTRACT

System for generating random numbers comprising an optical component configured to generate two optical signals, and two photodetectors connected to the optical component, wherein the first photodetector is adapted to receive the first optical signal and to generate a first electrical signal and the second photodetector is adapted to receive the second optical signal and to generate a second electrical signal, wherein the optical component is adapted to generate first and second optical signals that randomly result in first and second electrical signals where the first and second electrical signals are either equal or one is larger than the other, the system characterized in that the photodetectors are adapted to transmit the first and second electrical signals to a comparator, wherein the comparator is adapted to provide an output based on a comparison of the first and second electrical signals, thereby providing the random number.

### CROSS REFERENCE TO RELATED APPLICATIONS

This application is a continuation of International Application No. PCT/EP2020/061594, filed on Apr. 27, 2020, which claims priority under 35 U.S.C. § 119 to Application No. EP 19382318.4 filed on Apr. 26, 2019, the entire contents of which are hereby incorporated by reference.

### FIELD

The present invention relates to a system for generating random numbers and a method for generating random numbers.

### BACKGROUND

Related art systems are known for generating random numbers. Those systems can, in principle, be divided into two distinct technical approaches.

The first technical approach uses complex algorithms and initial conditions, also referred to as seeds (like the date), in order to calculate pseudo random numbers, that, preferably, have a most even distribution over a specific interval (usually 0 to 1).

While those systems only require a computer for generating the random numbers, they suffer from problems with a specific algorithm being used that results in a sequence of random numbers that can be fully predicted, even when showing good statistical results. In addition to being predictable, pseudo-random number generators also show finite lengths, i.e., after a given number of produced bits, they start repeating the same sequence again.

On the other hand, other approaches use physical systems that have random properties from which random numbers are extracted. Some approaches, for example, use a reference signal, for example generated by a direct current source emitting a specific voltage, and a laser system that causes a specific voltage signal at a photodiode. The electrical signals of the reference source and the photodiode can, then, be compared and, if the signal generated by the photodiode is larger than that of the reference signal, the value can be set to 1 whereas, in any other case, the value is 0.

A specific subset of physical random number generators are based on measuring quantum systems. In this way, randomness is generated directly by sampling the dynamics of a quantum process, which, under proper conditions, enables the generation of totally unpredictable random numbers. As an example, the phase diffusion process in pulsed semiconductor lasers can produce random numbers from the quantum mechanical process of spontaneous emission.

While, in theory, the numbers created are in fact perfect random numbers (i.e., it is completely unpredictable whether the obtained value at a specific measurement is 1 or 0), the real physical systems suffer from issues like small fluctuations in the reference signals or temperature, among many other practical imperfections. This can lead to a shift in the probability distribution, thereby not resulting in perfect random numbers. Eliminating these issues usually requires significant effort and, therefore, also results in larger systems and lower frequency of random number generation as well as increased costs.

In “Generation of fresh and pure random numbers for loophole-free Bell tests” by Carlos Abellan et al., a method for extraction of randomness from spontaneous emission events less than 36 ns in the past, giving output bits with excess predictability below 10-5 and strong metrological randomness assurances. This randomness strategy satisfies the stringent requirements for unpredictable basis choices in current “loophole-free Bell tests” of local realism.

Further, “Fast physical random number generator using amplified spontaneous emission” by Caitlin R. S. Williams et al. provides a report of a 12.5 Gb/s physical random number generator (RNG) that uses high-speed threshold detection of the spectrally-sliced incoherent light produced by a fiber amplifier. The system generates a large-amplitude, easily measured, fluctuating signal with bandwidth that is constrained only by the optical filter and electrical detector used. The underlying physical process (spontaneous emission) is inherently quantum mechanical in origin, and therefore cannot be described deterministically. Unlike competing optical RNG approaches that require photon counting electronics, chaotic laser cavities, or state-of-the-art analog-to-digital converters, the system employs only commonly available telecommunications-grade fiber optic components and can be scaled to higher speeds or multiplexed into parallel channels. The quality of the resulting random bitstream is verified using industry-standard statistical tests.

Additionally, “Self-balanced real-time photonic scheme for ultrafast random number generation” by Pu Li et al. proposes a real-time self-balanced photonic method for extracting ultrafast random numbers from broadband randomness sources. In place of electronic analog-to-digital converters (ADCs), the balanced photo detection technology is used to directly quantize optically sampled chaotic pulses into a continuous random number stream. Benefitting from ultrafast photo detection, this method can efficiently eliminate the generation rate bottleneck from electronic ADCs which are required in nearly all the available fast physical random number generators. A proof-of-principle experiment demonstrates that using our approach 10 Gb/s real-time and statistically unbiased random numbers are successfully extracted from a bandwidth-enhanced chaotic source. The generation rate achieved experimentally here is being limited by the bandwidth of the chaotic source. The method described has the potential to attain a real-time rate of 100 Gb/s.

Furthermore, “Fast physical random bit generation with chaotic semiconductor lasers” by Atsushi Uchida et al. discusses how good quality random bit sequences can be generated at very fast bit rates using physical chaos in semiconductor lasers. Streams of bits that pass standard statistical tests for randomness have been generated at rates of up to 1.7 Gbps by sampling the fluctuating optical output of two chaotic lasers.

Furthermore, “A robust random number generator based on differential comparison of chaotic laser signals” by Jianzhong Zhang et al. shows a robust real-time random number generator by differentially comparing the signal from a chaotic semiconductor laser and its delayed signal through a 1-bit analog-to-digital converter. The probability density distribution of the output chaotic signal based on the differential comparison method possesses an extremely small coefficient of Pearson's median skewness (1.5×10⁻⁶), which can yield a balanced random sequence much easily than the previously reported method that compares the signal from the chaotic laser with a certain threshold value. Moreover, it is experimentally demonstrated that the method can stably generate good random numbers at rates of 1.44 Gbit/s with excellent immunity from external perturbations.

### SUMMARY

According to the techniques of the present disclosure, provided for herein are apparatuses, systems and methods for generating random numbers that may yield improved results with respect to the even distribution of the random numbers over the chosen interval, while at the same time reducing the complexity of random number generators.

A system for generating random numbers is provided, the system comprising an optical component that is adapted to generate two optical signals, and two photodetectors connected to the optical component, wherein the first photodetector is adapted to receive the first optical signal and to generate a first electrical signal based on the first optical signal and the second photodetector is adapted to receive the second optical signal and to generate a second electrical signal based on the second optical signal, wherein the optical component is adapted to generate first and second optical signals that randomly result in first and second electrical signals where the first and second electrical signals are either equal or one is larger than the other, the system characterized in that the photodetectors are adapted to transmit the first and second electrical signals to a comparator, wherein the comparator is adapted to provide an output based on a comparison of the first and second electrical signals, thereby providing the random number.

According to the techniques of the present disclosure, an optical component adapted to generate at least two optical signals preferably refers to a system that produces optical signals having a specific phase relationship between them, as further described in the description.

It is noted that the comparator is, according to the techniques of the present disclosure, intended to provide the output by using the first and second electrical signals as they are generated by the photodetectors. Thus, no intermediate hardware or processing component that actively alters the first and second electrical signals or generates an intermediate signal to be provided to the comparator is provided between the photodetectors and the comparator in the preferred embodiments. The comparator may be any hardware component adapted to perform this operation. Specifically, it can be any analog-to-digital converter and specifically a limiting amplifier can be used. Also, a multibit analog to digital converter can be used. This convertor does not only use two incident signals (for example one signal of the first photodetector and one signal of the second photodetector) but uses a series of such signals to generate a multibit output. Thus, the term comparator is to be seen as any hardware component adapted to provide an output signal based on the comparison of the first and second electrical signals, where this output is preferably a definite output. In this context, a definite output means that the output is the same for identical results of the comparison.

The above-described arrangement may show increased uniformity of the probability distribution with respect to obtaining either a value 1 or a value 0 by the comparator, while also achieving a high frequency of random number generation. This is specifically the case because the only component used for transforming the optical interference signal to the random numbers is (the photodetectors and) the comparator, thereby eliminating the need for subtractors and other hardware components that usually only have a comparably small processing frequency of signals and/or introduce noise and imperfections, thus reducing the unpredictability of the generated random bits. This is typically the case in the homodyne detection scheme in quantum optics, where the two quadratures of the optical field are first subtracted and then sent to a digitizer. According to the techniques of the present disclosure, this process can be simplified by sending the signals directly into the differential digitization scheme. This reduces the number of hardware components needed and noise, and therefore also the size, the cost and improves the quality of the digitization process. In randomness generation this solves key limitations to obtain high-quality and highly integrated systems.

According to a further embodiment, the optical component of the system comprises two laser sources, an interferometer arranged and adapted with respect to the laser sources to achieve interference between laser light emitted from the first laser source (also called the first laser beam) and the laser light emitted from the second laser source (also called the second laser beam), wherein the relative phase of the laser light emitted from the first laser source and the laser light emitted from the second laser source is random, wherein the interferometer, which can be built for instance using a multimode interferometer (MMI), is adapted to generate at least two interference beams, wherein the interferometer may be further adapted to apply a phase shift to at least one of the interference beams and the interferometer is adapted to transmit the first interference beam to the first photodetector for generating the first electrical signal and the second interference beam to the second photodetector for generating the second electrical signal. Note that due to energy conservation, the two output interference beams show a certain phase relationship. For instance in the case of two output interference signals, these two outputs will show a phase relationship of 90°, namely, when the interference is constructive in one interference beam it must be destructive in the other.

It is noted that this embodiment covers cases where exactly one interference beam is provided to exactly one photodetector, i.e., the first interference beam is transmitted to the first photodetector only and the second interference beam is transmitted to the second photodetector only. This embodiment also covers cases where both interference beams are provided to both photodetectors.

Applying a phase shift to at least one of the interference beams also covers the case where a phase shift is applied to each of the interference beams. In this case, the phase shift applied to the first interference beam is preferably different from that applied to the second interference beams.

When application of a phase shift to an interference beam is mentioned, this does not only cover the case where the phase of the interference beam (comprising the laser light of the first laser source and the laser light of the second laser source in interference) is changed. It is also intended to cover cases where only the phase of one of the laser lights constituting the interference beam is changed. For example, within the interferometer and before generating at least one of the interference beams, a phase shift can be applied to at least one of the laser light of the first laser source and the laser light of the second laser source. The application of an (intentional additional) phase shift to the interference beam can be achieved by positioning for example a known λ-plate in the path of the interference beam.

The mentioned phase shift is not necessarily further specified. In fact, the phase shift can be a (fixed and predetermined) arbitrary value. While a specific phase shift by 7E can be preferred, any other phase shift can be thought of. For example, the phase shift of one interference beam may be ¾π. In one embodiment, the interferometer is a Michelson-Morley-interferometer or a Mach-Zehnder-interferometer with two optical output ports, wherein the first optical output port is connected to the first photodetector and the second optical output port is connected to the second photodetector.

It may be intended that the Michelson-Morley-interferometer comprises two input ports, one for the first laser source and one for the second laser source where the beams are provided to a semitransparent mirror, preferably with an incident angle of 90°. Both laser beams, i.e., the first laser beam (the laser light emitted from the first laser source) and the second laser beam (the laser light emitted from the second laser source) are thus split in one beam that is transmitted through the semitransparent mirror and one beam that is only reflected. The reflected beam will experience a shift in phase of π (i.e., 180°) whereas the transmitted beam does not.

Using such an interferometer allows for a compact design while achieving high physical stability of the generation of the interference beams.

In another embodiment, the interferometer is a Mach-Zehnder-interferometer and one laser source is used. The signal generated by the laser is sent to the input of the Mach-Zehnder interferometer, which is comprised of a first beam splitter, with a preferably 50/50 splitting ratio, which produces two optical beams that are connected to a second beam splitter, with preferably 50/50 splitting ratio, via two different optical paths, one of which is longer than the other, introducing a delay between the two optical beams. The second beam splitter performs therefore the interference between the two optical beams, one being a self-delayed version of the other one.

In a further embodiment, the laser sources are laser diodes. Laser diodes can be miniaturized significantly and only require little amounts of energy. Furthermore, they show advantageous pulsing properties when driving one of the laser sources in pulse mode.

In a further embodiment, the first laser source and the second laser source are connected to a multimode interferometer, preferably configured to generate two output interference beams.

In a further embodiment, the interferometer is configured in a 90°-hybrid configuration, thus providing four optical output interference beams with phase relationships of 0°, 90°, 180° and 270°. The output of each interference beam is sent to four independent photodetectors. The electrical signals corresponding to beams with phase relationship of 0° and 180° are sent to the two input ports of a comparator and the optical beams corresponding to 90° and 270° to another comparator. In this embodiment the two quadratures of the electromagnetic field are used, thus doubling the random number generation capacity.

In a further embodiment, the first laser source is adapted to be driven in constant wave mode and the second laser source is adapted to be driven in pulse mode; or the first laser source and the second laser source are adapted to be driven in pulse mode; or the first laser source and the second laser source are adapted to be driven in continuous wave mode; or only one laser source is driven in continuous wave mode whereas the other input port is left open.

According to the techniques of the present disclosure, the constant wave mode means that the first laser source constantly and continuously emits a laser beam, at least over a period of time that is 10⁵ times larger than the pulse repetition rate f⁻¹ (inverse of the pulse repetition rate) of the laser source driven in pulse mode. The pulse mode, according to the techniques of the present disclosure, means that the second laser source periodically emits (short) laser pulses of a pulse repetition rate f, where f is the pulse repetition rate indicating the number of consecutive pulses per second. This embodiment allows for creating random numbers at a high frequency while providing a physically stable system.

In a more specific realization of this embodiment, the second laser source (or any of the laser sources intended to be driven in pulse mode) is adapted to be driven in a power area ranging from a value below the lasering threshold to the lasering threshold. This means that the laser source is driven, when not emitting a pulse, with a power that is below the lasering threshold, thus reducing the stress to the laser source. For example, the power may be 70% or may be less than 60%, for example 20% or even 0%. It is also possible to drive the second laser source (or any of the laser sources intended to be driven in pulse mode) with inverted power, i.e., inverted electrical power source.

Additionally, the pulse repetition rate with which the second laser source (or any of the laser sources intended to be driven in pulse mode) reaches the lasering threshold can be greater than 100 MHz, or greater than 500 MHz or greater than 1 GHz. It can also be smaller than 100 MHz. With these embodiments, a significant amount of random numbers can be generated.

It can also be provided that the laser sources are connected to the interferometer by a separate wave guides and/or the interferometer can be connected to each of the photodetectors by a separate wave guide. Such wave guides can reduce environmental influences on the signals generated, thereby stabilizing the generation of random numbers also when environmental conditions change.

In a further embodiment, a tempering system for tempering the laser sources can be provided, the tempering system being adapted to regulate the temperature of the first and second laser sources independently. Changes in temperature, which could result in the lasering properties of the first and/or second laser sources changing, can thus be controlled and reduced.

One method for generating random numbers according to the techniques of the present disclosure uses a system or apparatus comprising an optical component, two photodetectors connected to the optical component and a comparator connected to the photodetectors, the method comprising generating, by the optical component, two optical signals and transmitting the first optical signal to the first photodetector and the second optical signal to the second photodetector, generating, by the first photodetector, a first electrical signal based on the first optical signal and generating, by the second photodetector, a second electrical signal based on the second optical signal, wherein the first and second optical signals randomly result in first and second electrical signals where the first and second electrical signals are either equal or one is larger than the other, the method characterized by transmitting the first electrical signal and the second electrical signal to the comparator and comparing, by the comparator, the first and second electrical signals and providing, by the comparator, an output based on the comparison of the first and second electrical signals, thereby providing the random number.

Thereby, true random numbers can be generated at high frequency with a stable and simple digitization scheme.

In one further embodiment, the optical component comprises two laser sources and an interferometer and wherein generating the first and second optical signals comprises emitting, by each of the laser sources, laser light into the interferometer, wherein the relative phase of the laser light emitted by the first laser source and laser light emitted by the second laser source is random, generating, by the interferometer, two interference beams, the interferometer transmitting the first interference beam to the first photodetector to generate the first electrical signal and the second interference beam to the second photodetector to generate the second electrical signal.

This method achieves increased uniformity in probability distribution for the values 0 and 1 obtained as output from the comparator, while also resulting in a high frequency of random number generation and simplified digitization circuitry.

In one embodiment, the output of the comparator is 1 in case the first signal is larger than the second signal and 0 in any other case. The “size” of the signals may be a voltage or current of the first and second electrical signals. The term “size” may refer to physical values like the amplitude of the signal, the voltage or current associated with the signal or the like.

The phase relation of the first and second laser beam might be governed by the laws of quantum physics. The phase of a laser beam follows the spontaneous emission that finally results in the laser beginning lasering. This spontaneous emission and specifically its phase, however, cannot be predicted and the probability for obtaining, for a laser starting lasering, a specific phase out of all possible phases is identical for all potential phases. This results in the relative phase of the first and second laser beams being completely random. Because of this, some of the signals generated will show a first electrical signal being larger than the second electrical signal and some will show the opposite, thus resulting in a uniform probability distribution. It is noted that the perfect randomness of the phase is achieved only if the laser has experienced a sufficiently large phase diffusion. This can be accomplished for a pulsed laser with an off-time of the lasering that is below 100 ps. In other cases, the probability distribution of the phases usually follows a Gaussian distribution.

In one embodiment, the first laser source is driven in constant wave mode and the second laser source is driven in pulse mode; or the first and second laser sources are driven in pulse mode; or the two laser sources are driven in constant wave mode; or one laser is driven in constant wave mode while the other is completely switched off.

In a more specific realization of this embodiment, the second laser source (or any of the laser sources intended to be driven in pulse mode) is periodically driven in a power area ranging from a value below the lasering threshold to the lasering threshold, wherein the second laser source periodically reaches the lasering threshold. Reaching the lasering threshold will result in the second laser source emitting a laser pulse with arbitrary phase with respect to the phase of the laser beam emitted by the first laser source, thereby allowing for generating the random number. By using this area of power, the physical stress to the second laser source can be reduced while separating the areas of pulse generation from each other by phases where no pulses are generated by the second laser source, thus reducing the noise in the signals generated. For example, the power may be 70% or may be less than 60%, for example 20% or even 0%. It is also possible to drive the second laser source (or any of the laser sources intended to be driven in pulse mode) with inverted power, i.e., inverted electrical power source. By those measures, spontaneous but unintended lasering of the second laser source (or any of the laser sources intended to be driven in pulse mode) can be avoided efficiently, thereby reducing the noise in signal generation.

It can also be provided that a pulse repetition rate with which the second laser source reaches the lasering threshold is greater than 100 MHz, or greater than 500 MHz or greater than 1 GHz. It can also be smaller than 100 MHz. Depending on the pulse repetition rate chosen, a significant amount of random numbers can be generated.

In a further embodiment, a tempering system regulates the temperature of the first and second laser sources independently. Thereby, changing environmental conditions having influence on the temperature of one of the laser sources can be eliminated to physically stabilize the system.

In a more specific embodiment, the tempering system regulates the temperatures such that a difference in the temperature of the first laser source and the temperature of the second laser source is smaller than 0.1K. Negative impacts on the generated laser beams due to varying temperatures of the laser source can thus be suppressed, thereby reducing the unintended noise in the generated signals.

### BRIEF DESCRIPTION OF THE DRAWINGS

FIG. 1 shows a system for generating random numbers according to one embodiment.

FIGS. 2a and 2b show two embodiments of interferometers.

FIG. 3 shows a system for generating random numbers according to a further embodiment.

### DETAILED DESCRIPTION

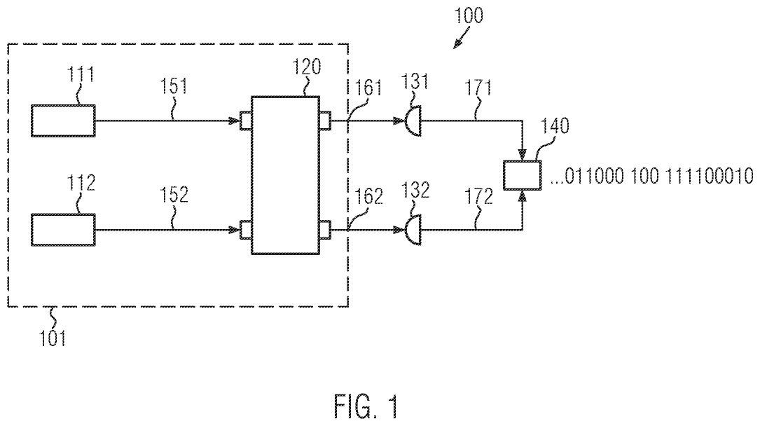

FIG. 1 shows a system 100 for generating random numbers.

The system 100 can either have macroscopic scales, i.e., have dimensions larger than 1 cm or several centimeters but it can also be implemented as a system on a chip having only microscopic scale, i.e., being smaller than 1 cm, preferably smaller than 0.5 cm.

In a preferred embodiment, the system 100 is provided on an integrated chip that can, for example, be included in a smartphone and has dimensions preferably smaller than 1 cm.

Though a special implementation of the system is depicted in FIG. 1, the general concept according the techniques of the present disclosure refers to a system and a method for generating random numbers, where the system comprises an optical component that is adapted to generate two optical signals, and two photodetectors connected to the optical component, wherein the first photodetector is adapted to receive the first optical signal and to generate a first electrical signal based on the first optical signal and the second photodetector is adapted to receive the second optical signal and to generate a second electrical signal based on the second optical signal, wherein the optical component is adapted to generate first and second optical signals that randomly result in first and second electrical signals where the first and second electrical signals are either equal or one is larger than the other. According to the techniques of the present disclosure, the photodetectors are adapted to transmit the first and second electrical signals to a comparator wherein the comparator is adapted to provide an output based on a comparison of the first and second electrical signals, thereby providing the random number.

In FIG. 1, the optical component (101) may be considered to comprise all the elements 111, 112 and 120 and the optical signal generated by this optical component may be the signals 161 and 162 as explained below.

While the examples provided in the following figures concentrate on realizations using laser sources and interferometers for generating the optical signals that are finally detected by the photodetectors, any other optical system that can generate two optical signals that have a random property with respect to each other that can be detected by photodetectors and translated into electrical signals for comparison by the comparator is encompassed by the present the techniques of the present disclosure.

The exemplary system 100 comprises two laser sources, a first laser source 111 and a second laser source 112. The laser sources are preferably adapted to transmit a first laser beam (also called first laser light emitted by the first laser source) 151 and a second laser beam (also called second laser light emitted by the second laser source) 152 (for the first and second laser sources, respectively) with similar, preferably identical frequency. However, due to the laws of quantum physics, the phase φ1 of the first laser beam and the phase φ2 of the second laser beam are random. Though reference is made to laser “beams,” at least one of the first and second laser sources can be adapted to generate and emit laser pulses (also covered by the term “laser light”).

The first laser beam and the second laser beam are then both introduced into an interferometer (like a Michelson-Morley-interferometer or a Mach-Zehnder-interferometer) 120. The interferometer is adapted to generate, from the first and second laser beams, a first interference beam 161. As another preferred embodiment, the interferometer may be a multi-mode interferometer.

Additionally, the interferometer is adapted to generate a second interference beam. This interference beam 162 from the first laser beam and the second laser beam.

According to the preferred embodiments, the interferometer is adapted to interfere the two input beams with a 50/50 power balance to two output ports, thus producing a complementary signal (i.e., the signal in the two output ports has a shift of for example 180° or 90°, thus conserving the energy). When the signal from the two laser beams interfere at the output ports, it creates an interference pattern depending on the phase of each laser beam.

The system further comprises two photodetectors 131 and 132. Those are arranged such that the first interference beam 161 generated by the interferometer can be transmitted to the first photodetector 131 and the second interference beam 162 generated by the interferometer can be transmitted to the second photodetector 132. The photodetectors may be arbitrarily designed. For example, they can be implemented as photo multipliers or commonly known photo diodes. Also, CCD sensors may be used. Preferably, photodetectors are used that have a high detection frequency, i.e., allow for detecting events at a frequency of several 100 MHz, preferably up to 1 or 2 GHz.

The photodetectors create, from the first interference beam and the second interference beam, a first electrical signal 171 (by the first photodetector 131) and a second electrical signal 172 (by the second photodetector 132). Both signals are provided to a comparator 140. This can be facilitated for example by transmitting the signals from the photodetectors 131 and 132 via electrical conductors like wires to the comparator or waveguides in the case of integrated circuits.

The electrical signals may show different voltages or currents depending on the first and second interference beams.

The comparator works in its ordinary sense, i.e., provides an output that is either 1 if the first electrical signal (i.e., for example the voltage of the first electrical signal) is larger than the second electrical signal (i.e., for example its voltage) and an output that is 0 in any other case. The comparator can also be embodied, for example, as a limiting amplifier or any other hardware component or software component adapted to provide the above mentioned output based on the optical signals and the respective comparison.

Due to the random relative phase of the first laser beam and the second laser beam to each other, it cannot be predicted how the output of the comparator will be, i.e., whether it is 1 or 0. According to the techniques of the present disclosure, this can be used to create a significant amount of random numbers. For this, in one embodiment, one of the laser sources, for example the first laser source 111, is driven in constant wave mode as a “reference signal”. The constant wave mode here means that the first laser source continuously emits the first laser beam 151 at least for a period of time. If the environmental conditions of the first laser source can be regulated to be perfectly constant, this reference signal is constant over a long period of time, thereby reducing any unintended noise in the reference signal and any unintended influence on the interference beams generated.

The second laser source 112 can, according to this embodiment, be driven in pulse mode, i.e., can be provided to transmit a laser pulse periodically. In order to achieve this, the second laser source can be driven at a power close to the lasering threshold. The lasering threshold is the power that has to be introduced into the second laser source for achieving lasering. When using, as the second laser source (but also perhaps as the first laser source), a laser diode, pulse repetition rates (measured in number of pulses per second) can be obtained that range from several MHz to even GHz. This pulse repetition rate is not related to the frequency of the laser pulse generated but to the number of pulses generated per second. Let this pulse repetition rate be f. It is then preferred that the time t for which the first laser source continuously emits the first laser beam is at least t=105f−1, more preferably t=1010f−1 to have a reference signal that is constant over a significant number of pulses generated by the second laser source.

It is noted that instead of driving one of the laser sources in constant wave mode also embodiments are intended where both laser sources are driven in pulse mode. In such a case, no continuously emitted laser beam of one of the laser sources is used as “reference” signal, but the obtained pulses are merely compared to each other, thereby achieving a corresponding result as the one explained above for the case where one of the laser sources is driven in constant wave mode and the other is driven in pulse mode.

As the phase of each of these generated pulses is completely random with respect to the continuous laser beam generated by the first laser source, it cannot be predicted how the interferences beams will look like. However, it is clear that they will create an interference signal that is between (and comprises) complete distinction and full amplification. As the interference beams (or at least one of them) experience a phase shift relative to each other, the signals obtained by the photodetectors will differ from each other unless the first and second laser beams result in complete distinction or full amplification.

In any case, the first and second interference beams will either be equal to each other or the one will result in a signal (for example voltage) of the photodetector being larger than the other. This allows the comparator to generate a clear output signal that is either 0 or 1 although this output signal cannot be predicted, thus being completely random.

The output provided by the comparator will, at first, be a series of digits, i.e., of 0s and 1s is depending on the actual phase relation of the first laser beam and second laser beam. This series of digits can then be used as the random number by, for example, using the sequence of 0s and 1s as the random numbers themselves (for example, after every millionth pulse, the series is aborted and used as a random number and the consecutive digits obtained are used as the following random number). Furthermore, it can also be provided that the number of digits is used to calculate a real number, for example an integer number, that will also be completely arbitrary and can, thus, be used as the random number.

There is no limitation with respect to how the digits are actually provided or used as random number. Among their potential applications, they can be used to, for example, encrypt sensitive data and specifically sensitive data that is transferred from a first computing entity, like a smartphone, to a second computing entity, like a login server for logging into a service like an online banking account. Additionally, the random numbers generated can be used for encrypting communication like emails or instant messages transmitted between entities, like two smartphones or a plurality of smartphones. In the last case, where the random numbers are used for encrypting the communication between smartphones or other small computing devices, it is preferred that the system for generating random numbers is provided on the respective computing systems (smartphones or the like) themselves. Therefore, it is preferred that in this case the system is miniaturized as far as possible.

Though, in principle, the first and second laser sources can be laser sources that emit laser beams at an arbitrary frequency ranging from the infrared over optical to even ultraviolet signals, it is preferred that the laser sources are selected from laser sources that have a wavelength that it is much smaller compared to the dimensions of the system for generating random numbers in order to avoid unintended noise due to refraction or other optical disturbances. Specifically, laser sources may be preferred that emit laser beams with a wavelength that is 10⁻² or even more preferred 10⁻⁵ times the smallest relevant length of the optical components of the system for generating random numbers. The optical components are all components that have influence on the laser beams transmitted by the first laser source 111 and the second laser source 112. This, for example, refers to wave guides used for transmitting the first and second laser beams to the interferometer, any physical components within the interferometer, like the incident arms and the transmitting arms, and also wave guides that transmit the first and second interference signals to the first and second photodetectors.

In view of this, laser sources may be preferred that either transmit optical light in the range of some 100 nm or ultraviolet light. A preferred wavelength may be between 1300 and 1600 nm. Most preferred, the wavelength is 1330 nm or 1550 nm.

When providing the system 100 on an integrated chip, all above mentioned components are provided on the integrated chip. Other components, for example a frequency generator that causes the pulsed lasering of the second laser source, may also be provided on the chip or such additional components may be provided as separate hardware.

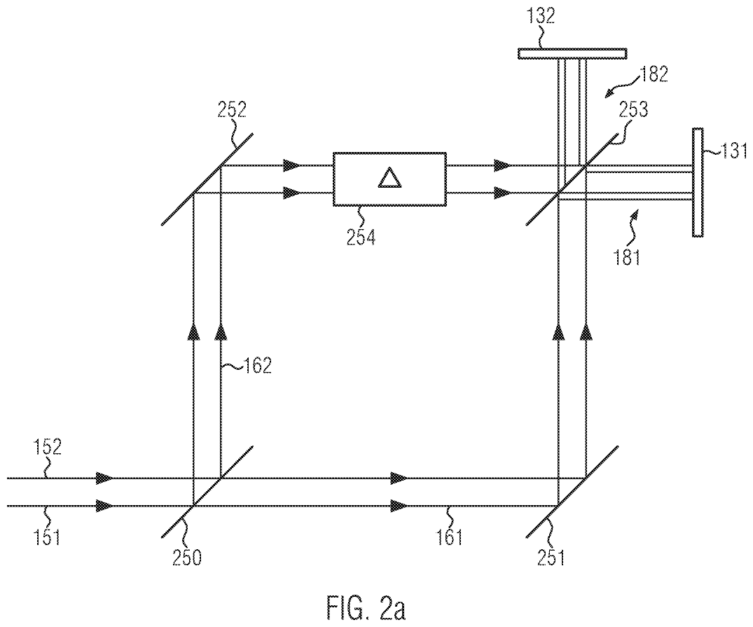

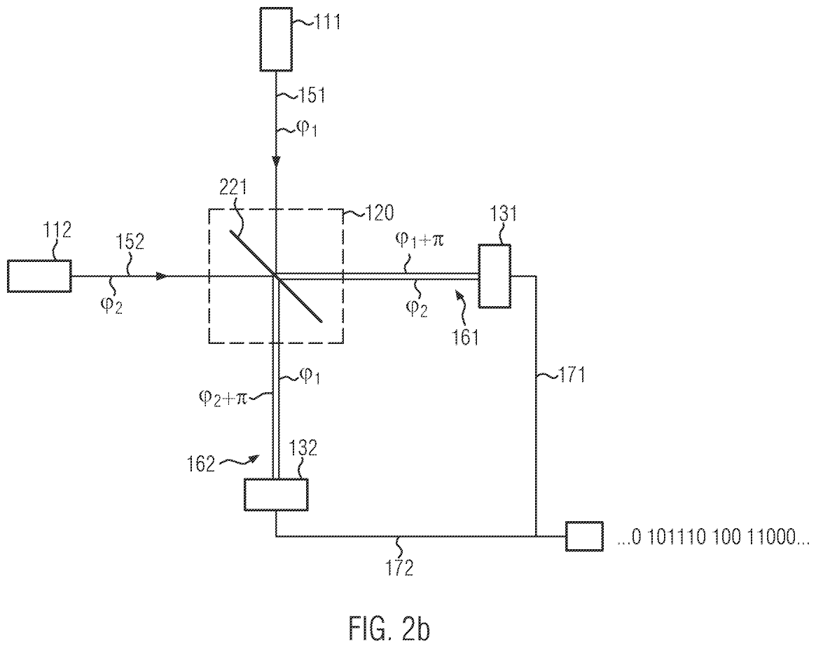

Referring now to FIGS. 2a and 2b, more specific realizations of the general embodiment according to FIG. 1 are described. In these embodiments, specific realizations of the interferometer are chosen.

In the case of FIG. 2a, the interferometer is a Mach-Zehnder-interferometer 120. This interferometer comprises at least one input port through which the laser beams 151 and 152 generated by the first and second laser sources are introduced. The interferometer 120 further comprises two mirrors 251 and 252 as well as two semitransparent mirrors, 250 and 253. Further, a phase-shift component 254 (like a λ/4 (quarter-wave) or λ/2 (half-wave) plate) is provided between the mirror 252 and the semitransparent mirror 253. Instead, it could also be provided between the semitransparent mirror 250 and the mirror 251. Also other realizations are possible. In any case, the interferometer comprises at least one phase-shift component 254 through which one of the interference beams travels and the other one does not.

The incident laser beams 151 and 152 hit the semitransparent mirror 250. Here, two (intermediate) interference beams, a first interference beam 161 and a second interference beam 162 are created from the first and second laser beams. The first interference beam 161 travels from the semitransparent mirror 250 to the mirror 251 and further to the semitransparent mirror 253. The second interference beam travels from the semitransparent mirror 250 to the mirror 252 and is reflected in the direction of the phase-shift component 254. In this phase-shift component, the phase of the interference beam 162 experiences a well-defined phase shift, for example by π, corresponding to λ/2. Arbitrary other values of phase shift can be thought of. The phase shift, however, is different from 2nπ, where n is an integer.

After that, the interference beam travels to the semitransparent mirror 253. Here, the first intermediate interference beam 161 and the second intermediate interference beam 162 generate a first interference beam 181 and a second interference beam 182. The first interference beam travels to the first photodetector 131, resulting in the generation of a first electrical signal. The second interference beam 182 travels to the second photodetector, causing a second electrical signal.

The beams (including all interference beams and the incident laser beams) can propagate through suitable waveguides like glass fiber or other waveguides suitable for the respective wavelength used.

In the embodiment described in FIG. 2a, it is one of the (intermediate) interference beams that experiences a phase shift in the phase-shift component 254. In the case of FIG. 2b, it is one of the incident laser beams that experiences the phase shift.

In the case of FIG. 2b, the interferometer 120 is embodied as a Michelson-Morley-interferometer that comprises a semitransparent mirror 121. The first laser source 111 is arranged to transmit the first laser beam 151 with a phase φ1 onto a first side of the mirror 121. The first laser beam may be input into the interferometer through a not further shown (optical) input port. The second laser source 112 is arranged to transmit the second laser beam 152 with a phase φ2 to the opposite side of the semitransparent mirror, for example by introducing it into the interferometer by a likewise not further shown (optical) input port. By using a semitransparent mirror, the laser beams will be split into a portion that is reflected by the mirror 221 and a portion that is transmitted through the mirror. The laser beams that are reflected at the surface of the mirror 221 will experience a phase shift by it whereas those laser beams that are transmitted through the mirror will not experience such a phase shift.

The arrangement chosen results in the interference beams 161 and 162 where, for the first interference beam, the phase φ1 of the first laser beam is shifted by π and thus has a phase φ1+π. For the second interference beam, the phase of the second laser beam 152 experiences a shift by π and thus, after being reflected by the mirror 221, has a phase φ2+π. In propagation direction of the first and second interference beams, respectively, the first photodetector 131 and the second photodetector 132 are arranged to receive the first and second interference beams. The interference beams may leave the interferometer through suitable, not further shown (optical) output ports.

The Michelson-Morley-interferometer 120 may be realized by (optical) wave guides that are connected to the first and second laser source, respectively, for coupling in the first and second laser beams through the input ports into the interferometer. The wave guides may have identical length and may input the first and second laser beams, respectively, to the mirror 221. Additionally or alternatively, wave guides may be provided for receiving the interference beams 161 and 162 and guiding the interference beams to the photodetectors 131 and 132. These may be connected to or constitute the output ports.

In case, however, the system is miniaturized to dimensions much smaller than 1 cm, those wave guides may not be formed by, for example, glass fibers, but may just be wave guides through which the electromagnetic waves can travel without distinction or at least with a damping length larger than the distance between the mirror and the photodetectors (and/or the laser sources) or at least larger than 0.5 times the distance between the mirror 221 and the photodetectors (and/or the laser sources), respectively.

Thereby, it can be ensured that the interference beams incident on the photodetectors 131 and 132, respectively, still have enough signal strength for the photodetectors to result in a clearly detectable signal above the noise of the photodetectors themselves and any other noise of the system (for example thermal noise or the like).

While only two specific realizations of interferometers as optical components have been described above, it is noted that those are not limiting to the concepts disclosed herein and other optical components that generate two optical signals for the photodetectors can be employed. However, among those described, the Mach-Zehnder-interferometer may be preferred.

Another preferred realization of the interferometer is a multi-mode-interferometer. Such a multi-mode-interferometer and its functioning is known to the skilled person. As with the Mach-Zehnder interferometer and the Michelson-Morley-interferometer examples are given above for the case where the interference beam experiences a phase shift and the case where one of the laser beams constituting the interference beams experiences a phase shift, a detailed description of the multi-mode-interferometer is not provided here.

However, preferably, if a multi-mode-interferometer is provided as part of the optical component, this comprises two input ports, one for the first laser beam and one for the second laser beam, and two output ports, where the first interference beam is transmitted to the first photodetector via a first output port and the second interference beam is transmitted to the second photodetector via a second output port. Another preferred embodiment comprises two input ports, on for the first laser beam and one for the second laser beam and four output ports in a so-called hybrid 90° configuration, i.e., where the four output ports have relative phases of 0°, 90°, 180° and 270°.

Between the input ports and the output ports, a multi-mode-interference coupler is provided through which at least two eigen-modes can travel. Those eigen-modes correspond, in one embodiment, to at least two wavelengths (or frequencies, respectively) constituting at least one of the laser beams. Specifically, in the case one of the laser beams is provided as laser pulse, this is constituted by a (infinite) number of waves with specific frequencies. At least two of these frequencies (corresponding to wavelengths) correspond to eigen-modes of the multi-mode-interference coupler. Thus, at least these frequencies can travel through the coupler, thereby generating interference beams that can be detected at the photodetectors.

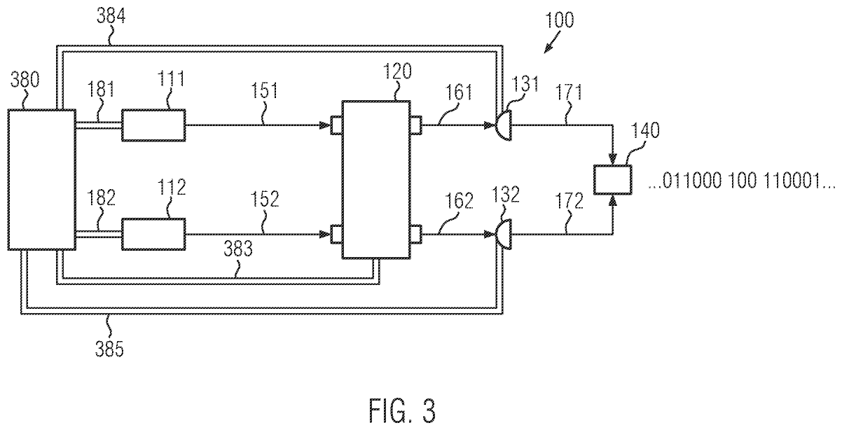

FIG. 3 shows a further embodiment of the system for generating random numbers. Herein, the components labelled with the same reference numerals as used in FIG. 1 are identical to the components also used in the embodiment according to FIG. 1. Their function will thus not be repeated here where this is not necessary.

In FIG. 3, a tempering system 380 is provided. This tempering system can comprise sensors (such as, for example, thermal sensors) for determining the environmental conditions, specifically the temperature, at least of the first and second laser sources 111 and 112. During the laser sources 111 and 112 emitting laser beams, their temperature will rise which can result in a change in their lasering behavior, thus having influence on the accuracy of the generation of the laser beams and, hence, the interference beams. This can be measured by the sensors.

Additionally, it can be provided that sensors are provided for measuring the thermal conditions of the interferometer and/or the photodetectors. As an increase in temperature can result, for example, in changes in the length of the arms of the interferometer (see for example the arms through which the first and second laser beams travel through the mirror 221 in FIG. 2b and the arms through which the interference beams travel from the mirror to the photodetectors), a change in temperature can result in a change in the length of those arms and, thus, in a change of the relative phase between the interference beams. Additionally, an increase in temperature can have influence on the properties of the mirror 221 and can lead to thermal vibrations on the surface of the mirror, thus also influencing the accuracy with which the interference beams can be generated and measured. Likewise, the photodetectors will have increased noise when the temperature rises.

To prevent noise from these issues, the tempering system 380 is connected at least to the first and second laser sources 111 and 112 (schematically depicted by the pipes 381 and 382, respectively) and can preferably independently regulate the temperature of the first and second laser sources. For macroscopic systems, for example, this can be achieved by heat exchanges and a cooling circuit through which a cooling medium like air or water is circulated in order to transport away heat emitted by the first and second laser sources. For microscopic systems, techniques as commonly used for cooling processors or (semi-)optical components in computers can be used. It may also be preferred for cases where the system is provided on a chip to integrate the tempering system directly on the chip. This can, for example, be achieved by placing a resistor on the chip through which current can flow. Depending on the current introduced into the resistor, the resistor will dissipate heat. This heat can be used to increase the temperature of the chip to a desired value.

By controlling the temperature of the first and second laser sources independently, the temperature of the first and second laser source can be maintained at a given (preset) temperature. In the case where the first laser source is driven in constant wave mode and the second laser source is driven in pulse mode, the thermal stress of the first laser source can be different from the thermal stress of the second laser source, thereby also resulting in the first laser source requiring another cooling compared to the second laser source. Therefore, it is preferred that the control of the temperature of the first and second laser source is completely independent from each other. Even further, it is preferred that the tempering system 380 can control the temperature of the first and second laser source with an accuracy of, for example, 2K, preferably 1K, more preferably 0.1K and more preferably 0.01K.

Additionally, or alternatively, it can also be provided that the tempering system can regulate the temperature of the interferometer 120 and/or the photodetectors 131 and 132. For this, the tempering system can be connected to the interferometer 120 and the photodetectors 131 and 132 by corresponding connections 383 and 384 and 385, respectively. The cooling of these components can be achieved in the same manner as described with respect to the laser sources 111 and 112.

With respect to the interferometer, it can be intended that separate cooling is provided for the mirror 221 described with respect to FIG. 2b, where such a mirror is provided in the interferometer. Additionally, any optical component of the interferometer can be separately cooled in order to keep its temperature at a specific value.

The cooling of the photodetectors 131 and 132 can also be provided in independent manner such that their temperature can be kept at a constant value.

As for the first and second laser sources 111 and 112, it can be provided that the temperature of the interferometer (and its respective components) as well as the photodetectors can be controlled with an accuracy of 0.1 K or preferably 0.01K.

Though not explicitly mentioned here, it can also be provided that any other components of the system 100 depicted in FIG. 1 are connected to the tempering system 380 and cooled where necessary. For example, in case wave guides are used for guiding the propagation of the first and second laser beams and the interference beams, a cooling of the same can be provided. Additionally, the photodetectors 131 and 132 will likely be connected to the comparator 140 by corresponding electrical conductors like cables or any other suitable techniques. These can also be cooled to reduce the thermal noise in the electrical signals transmitted from the first and second photodetectors to the comparator.

In order to keep the overall noise level at a minimum, it is preferred that the travelling paths of the first and second laser beams generated by the first and second laser sources as well as the travelling paths of the interference beams 161 and 162 are equal to each other and/or are preferably as short as possible. The same holds for the length of the electrical connection between the photodetectors 131 and 132 with the comparator 140. Thereby, additional noise that could have influence on the comparison of the first electrical signal and second electrical signal generated by the first and second photodetectors in the comparator can be reduced to a minimum.

Once the comparator has calculated the comparison between the first and second electrical signals, these are transformed into digits, i.e., 0 and 1. Such clear signals suffer less from noise and, thus, the length of the travelling path of the signals generated by the comparator can be almost arbitrary without resulting in a significant deterioration or reduction of signal strength in the output of the comparator. Therefore, additional cooling for any connection of the comparator to another computing entity or a control or reduction in the length of the transport path is not mandatory but can still be provided where appropriate.

In addition or alternatively, other techniques for reducing noise in the generated optical signals can be thought of. For example, the laser sources will usually not yield perfectly identical wavelengths for the generated laser beams. In such cases, the coherence length of the generated laser beams can be too small (corresponding to the frequency difference between the two laser beams being to large) to generate reliable random numbers with even probability distribution. In order to stabilize the wavelengths of the laser beams, additional carriers can be injected into the active medium of the laser sources. This will result in a change of the refractive index of the cavity and will thereby result in a tuning of the wavelength. This can be used by a control system to synchronize (also known as “tuning”) the wavelengths of the laser beams generated by the two laser sources exemplified above.

For example, one or more sensors can be provided for measuring the wavelengths of each of the generated laser beams preferably periodically. Alternatively, the wavelengths can be measured every 10's or the like. The measured wavelength of each laser beam can then be compared to a standard wavelength or to the wavelength of the other laser beam. Based on the result of this comparison, the amount of carriers injected in one or both laser sources can be changed so as to change the refractive index of the cavity and thus tune the wavelength. Thereby, the wavelengths can be synchronized with each other and stabilized over a longer period of time.

As it is not of relevance for the generation of the random numbers to have laser sources emitting both at a very specific wavelength but it is only necessary that both laser sources emit laser beams with (almost) identical wavelength to have a long coherence length (corresponding to a low beating frequency), it can be preferred that the wavelengths of the laser beams of the laser sources are only synchronized with each other but not tuned to a specific standard wavelength. Thus, shift of the wavelengths of both laser sources over time can be accepted as long as both wavelengths are synchronized with each other.

Preferably, the wavelengths of the laser beams emitted by the laser sources are synchronized such that the coherence length achieved is at least 10 times, preferably 100 times, more preferred 10⁵ times the maximum extension of the of system according to the techniques of the present disclosure. Specifically, the coherence length may be at least 10 times, preferably 100 times, more preferred 10⁵ times the optical distance (also called optical path length) between the laser sources and the photodetectors. Thereby, the noise due to the not perfectly synchronized wavelengths of the laser beams emitted by the laser sources is kept low and the generation of random numbers suffers from less failures.

Another, related aim can be to synchronize the laser sources in a manner that the frequency difference between the first and second laser beams is as small as possible. Preferably, this difference is smaller than the detection bandwidth of the photodetectors, for example at least 10 times smaller, preferably 100 times smaller, more preferred even 105 times smaller than the detection bandwidth of the photodetectors.

1. An apparatus comprising:
an optical component configured to generate a first optical signal and a second optical signal;
a first photodetector and a second photodetector, wherein the first photodetector is configured to receive the first optical signal and to generate a first electrical signal based on the first optical signal, and the second photodetector is configured to receive the second optical signal and to generate a second electrical signal based on the second optical signal; and
a comparator configured to receive the first and second electrical signals and provide a random number output based on a comparison of the first and second electrical signals.

2. The apparatus of claim 1, wherein the optical component comprises:
first and second laser sources configured such that a relative phase between first laser light emitted from the first laser source and second laser light emitted from the second laser source is random; and
an interferometer configured to interfere the first laser light and the second laser light to generate first and second interference beams, transmit the first interference beam to the first photodetector for generating the first electrical signal, and transmit the second interference beam to the second photodetector for generating the second electrical signal.

3. The apparatus of claim 2, wherein the interferometer comprises:
at least one of a Michelson-Morley-interferometer, a Mach-Zehnder-interferometer or a multimode interferometer;
a first optical output port connected to the first photodetector; and
a second optical output port connected to the second photodetector.

4. The apparatus of claim 2, wherein the first laser source comprises a first laser diode and the second laser source comprises a second laser diode.

5. The apparatus of claim 2, wherein the first laser source is configured to be driven in constant wave mode and the second laser source is configured to be driven in pulse mode, the first laser source and the second laser source are configured to be driven in pulse mode, the first laser source and the second laser source are driven in constant wave mode, and/or the first laser source is driven in constant wave mode and the second laser source is switched off or nonexistent.

6. The apparatus of claim 5, wherein the second laser source is configured to be driven in a power area ranging from a value below a lasering threshold of the second laser source to a value above the lasering threshold of the second laser source.

7. The apparatus of claim 6, wherein a pulse repetition rate with which the second laser source reaches the value above the lasering threshold is greater than 100 MHz.

8. The apparatus of claim 2, wherein the first and second laser sources are connected to the interferometer by separate waveguides and/or wherein the interferometer is connected to each of the photodetectors by a separate waveguide.

9. The apparatus of claim 2, further comprising a tempering system configured to regulate a temperature of the first laser source and a temperature of the second laser source.

10. A method comprising:
generating, via an optical component, first and second optical signals;
transmitting the first optical signal to a first photodetector;
transmitting the second optical signal to a second photodetector,
generating, via the first photodetector, a first electrical signal based on the first optical signal;
generating, via the second photodetector, a second electrical signal based on the second optical signal, wherein the first and second optical signals randomly result in first and second electrical signals;
transmitting the first electrical signal and the second electrical signal to a comparator;
comparing, via the comparator, the first electrical signal and the second electrical signal; and
providing, from the comparator, a random number based on the comparing of the first electrical signal and second electrical signal.

11. The method according to claim 10, wherein:
the optical component comprises first and second laser sources and an interferometer;
generating the first and second optical signals comprises emitting, by each of the laser sources, laser light into the interferometer, wherein a relative phase of laser light emitted by the first laser source and laser light emitted by the second laser source is random; and
generating the first and second optical signals further comprises generating, by the interferometer, two interference beams, the interferometer transmitting the first interference beam to the first photodetector to generate the first electrical signal and the second interference beam to the second photodetector to generate the second electrical signal.

12. Method of claim 11, wherein the first laser source is driven in constant wave mode and the second laser source is driven in pulse mode, or wherein the first laser source and the second laser source are driven in pulse mode.

13. Method of claim 12, wherein the second laser source is periodically driven in a power area ranging from a value below a lasering threshold of the second laser source to a value above the lasering threshold of the second laser source, wherein the second laser source periodically reaches the lasering threshold.

14. Method according to claim 13, wherein a pulse repetition rate with which the second laser source reaches the value above the lasering threshold of the second laser source is greater than 100 MHz.

15. Method of claim 11, further comprising regulating, via a tempering system, a temperature of the first laser source and a temperature of the second laser source.

16. Method of claim 15, wherein the tempering system regulates the temperature of the first laser source and the temperature of the second laser source such that a difference in the temperature of the first laser source and the temperature of the second laser source is smaller than 0.1K.

17. Method of claim 10, wherein an output of the comparator is 1 when the first electrical signal is larger than the second electrical signal.

18. The method of claim 10, wherein an output of the comparator is 0 when the first electrical signal is not larger than the second electrical signal.
